(19) United States
(12) Patent Application Publication
(10) Pub. No.: US 2019/0152410 A1
(43) Pub. Date: May 23, 2019

(54) TRANSPARENT RADIATIVE COOLING FILMS AND STRUCTURES COMPRISING THE SAME

(71) Applicant: Toyota Motor Engineering & Manufacturing North America, Inc., Erlanger, KY (US)

(72) Inventors: Gaohua Zhu, Ann Arbor, MI (US); Chengang Ji, Ann Arbor, MI (US); Debasish Banerjee, Ann Arbor, MI (US)

(21) Appl. No.: 15/818,203

(22) Filed: Nov. 20, 2017

(51) Int. Cl. B60R 13/00; B32B 15/04; B32B 27/06

(52) U.S. Cl. CPC B60R 13/00; B32B 15/04; B32B 2605/00; B32B 2307/412; B32B 27/06

(57) ABSTRACT

A transparent radiative cooling film includes an ultraviolet/infrared (UV/IR) cut layer and a radiative cooling layer extending across the UV/IR cut layer. The UV/IR cut layer may be formed by alternating layers of oxide and metal and/or by a color filter layer. The radiative cooling layer includes an oxide. The UV/IR cut layer is transparent to a first range of electromagnetic radiation in the visible spectrum, reflects or absorbs a second range of electromagnetic radiation in the UV spectrum, and reflects a third range of electromagnetic radiation in the IR spectrum. The radiative cooling layer is transparent to the first range of electromagnetic radiation in the visible spectrum and emits a fourth range of electromagnetic radiation in the IR spectrum with wavelengths between about 7.0 micrometers and about 18 micrometers such that the transparent radiative cooling film preserves the color of a surface while passively cooling the surface.

### TECHNICAL FIELD

The present specification generally relates to radiative cooling films and, more specifically, to transparent radiative cooling films.

### BACKGROUND

Radiative cooling films or coatings may be used to passively cool surfaces below ambient temperature. Such radiative cooling films include a reflective layer such that the radiative cooling films, and surfaces coated with the radiative cooling films, appear as a mirror. Accordingly, a surface with a desired color, e.g., a painted surface, appears as a mirror after it has been coated with a radiative cooling film. That is, colors of painted surfaces are not preserved when coated with known radiative cooling films.

Accordingly, a need exists for alternative radiative cooling films that preserve colors of surfaces onto which the radiative cooling films have been applied.

### SUMMARY

In one embodiment, a transparent radiative cooling film includes a transparent radiative cooling film formed from an ultraviolet/infrared (UV/IR) cut layer and a radiative cooling layer extending across the UV/IR cut layer. The UV/IR cut layer may include alternating layers of oxide and metal, a color filter layer, or a combination of alternating oxide and metals layers and a color filter layer. The transparent radiative cooling film transmits, reflects, absorbs and emits desired ranges of electromagnetic radiation such that a color of a surface coated with the transparent radiative cooling film is preserved (visible) and passively cooled. Particularly, when the transparent radiative cooling film is exposed to sunlight, an average transmission of a first range of electromagnetic radiation in the visible spectrum through the transparent radiative cooling film is equal to or greater than 60%, and an average reflection or an average absorption of a second range of electromagnetic radiation in the UV spectrum by the transparent radiative cooling film is equal to or greater than 60%. Also, an average reflection of a third range of electromagnetic radiation in the IR spectrum with wavelengths between about 1.0 micrometers (μm) and about 5.0 μm by the transparent radiative cooling film is equal to or greater than 60%, and an average emission of a fourth range of electromagnetic radiation in the IR spectrum with wavelengths between about 7.0 μm and about 18 μm from the transparent radiative cooling film is equal to or greater than 60%.

In some embodiments, the UV/IR cut layer is formed from the alternating layers of oxide and metal. In such embodiments, the alternating oxide layers are formed from at least one of TiO₂, SiO₂, CeO₂, Al₂O₃, Y₂O₃, Nb₂O₅, and combinations thereof, and the alternating metal layers are formed from at least one of Ag, Au, Cu, Ag—Al alloys, and Cu—Zn alloys. In such embodiments, the first range of electromagnetic radiation in the visible spectrum may be between about 0.380 μm and about 0.750 μm. Also, in such embodiments, the UV/IR cut layer may include at least three metal oxide layers with a metal layer positioned between each of the at least three metal oxide layers.

In other embodiments, the UV/IR cut layer is the color filter layer and the first range of electromagnetic radiation in the visible spectrum is between about 0.380 μm and about 0.450 μm, between about 0.450 μm and about 0.495 μm, between about 0.495 μm and 0.570 about μm, between about 0.590 μm and about 0.620 μm, or between about 0.620 μm and about 0.750 μm.

The radiative cooling layer may include SiO₂ and a polymer. For example, in some embodiments the radiative cooling layer may include a first SiO₂ layer and a second polymer layer extending across the first SiO₂ layer. In other embodiments, the radiative cooling layer may include SiO₂ particles disposed within a polymer layer.

In another embodiment, an article with a transparent radiative cooling film includes a surface with a color layer reflecting a predetermined color when exposed to sunlight and a transparent radiative cooling film extending across the color layer. The transparent radiative cooling film includes a UV/IR cut layer and a SiO₂ containing radiative cooling layer extending across the UV/IR cut layer. An average transmission of a first range of electromagnetic radiation in the visible spectrum through the transparent radiative cooling film is equal to or greater than 60%, and an average reflection or an average absorption of a second range of electromagnetic radiation in the UV spectrum by the transparent radiative cooling film is equal to or greater than 60%. Also, an average reflection of a third range of electromagnetic radiation in the IR spectrum with wavelengths between about 1.0 μm and about 5.0 μm by the transparent radiative cooling film is equal to or greater than 60%, and an average emission of a fourth range of electromagnetic radiation in the IR spectrum with wavelengths between about 7.0 μm and about 18.0 μm from the transparent radiative cooling film is equal to or greater than 60%.

In still another embodiment, a vehicle includes a body panel with a color layer reflecting a predetermined color when exposed to sunlight and a transparent radiative cooling film extending across the color layer. The transparent radiative cooling film includes a UV/IR cut layer and a radiative cooling layer extending across the UV/IR cut layer. The UV/IR may be formed from alternating layers of oxide and metal. In the alternative, or in addition to, the UV/IR cut layer may be formed from a color filter layer. The radiative cooling layer may be formed from SiO₂ and a polymer. When the transparent radiative cooling film is exposed to sunlight, an average transmission of a first range of electromagnetic radiation in the visible spectrum through the transparent radiative cooling film is equal to or greater than 60%, and an average reflection or an average absorption of a second range of electromagnetic radiation in the UV spectrum by the transparent radiative cooling film is equal to or greater than 60%. Also, an average reflection of a third range of electromagnetic radiation in the IR spectrum with wavelengths between about 1.0 μm and about 5.0 μm by the transparent radiative cooling film is equal to or greater than 60%, and emission of a fourth range of electromagnetic radiation in the IR spectrum with wavelengths between about 7.0 μm and about 18 μm from the transparent radiative cooling film is equal to or greater than 60%.

These and additional features provided by the embodiments described herein will be more fully understood in view of the following detailed description in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a side cross sectional view of a transparent radiative cooling film according to one or more embodiments disclosed and described herein;

FIG. 2 schematically depicts an isolated side cross sectional view of a UV/IR cut layer for the transparent radiative cooling film in FIG. 1 according to one or more embodiments disclosed and described herein;

FIG. 3 schematically depicts an isolated side cross sectional view of a UV/IR cut layer for the transparent radiative cooling film in FIG. 1 according to one or more embodiments disclosed and described herein;

FIG. 4 schematically depicts an isolated side cross sectional view of a radiative cooling layer for the transparent radiative cooling film in FIG. 1 according to one or more embodiments disclosed and described herein;

FIG. 5 schematically depicts an isolated side cross sectional view of a radiative cooling layer for the transparent radiative cooling film in FIG. 1 according to one or more embodiments disclosed and described herein;

FIG. 6 schematically depicts a vehicle with a body panel including a transparent radiative cooling film according to one or more embodiments disclosed and described herein;

FIG. 7 graphically depicts reflectance, transmission and absorption as a function of electromagnetic radiation wavelength for a transparent radiative cooling film according to one or more embodiments disclosed and described herein; and

FIG. 8 graphically depicts equilibrium temperatures for a blue paint layer, with and without a transparent radiative cooling film according to one or more embodiments disclosed and described herein, exposed to a solar simulation of 1 sun power (1000 W/m²).

### DETAILED DESCRIPTION

According to one or more embodiments described herein, a transparent radiative cooling film generally comprises an ultraviolet/infrared (UV/IR) cut layer and a radiative cooling layer extending across the UV/IR cut layer. As used herein, the term “transparent” refers to a film that allows light to pass through such that a color of a colored surface behind or underneath the film can be distinctly seen by an observer viewing the colored surface through the film. The term “UV/IR cut layer” as sued herein refers to a layer, or a plurality of layers, that block transmission (i.e., cut) UV electromagnetic radiation below about 0.380 micrometers (μm) and IR electromagnetic radiation above about 0.750 μm thereby leaving visible electromagnetic radiation passing through layer. The UV/IR cut layer is transparent to a first range of electromagnetic radiation in the visible spectrum and not transparent to a second range of electromagnetic radiation in the UV range and a third range of electromagnetic radiation in the IR range. As used herein, the term “UV range” or “UV spectrum” refers to electromagnetic radiation with wavelengths less than about 0.380 μm unless otherwise noted, the term “IR range” or “IR spectrum” refers to electromagnetic radiation with wavelengths between about 0.750 μm and 20.0 μm unless otherwise noted, and the term “visible electromagnetic radiation” or “visible spectrum” refers to electromagnetic radiation with wavelengths between about 0.380 μm and about 0.750 μm unless otherwise noted. The radiative cooling layer is transparent to the first range of electromagnetic radiation in the visible spectrum and emits thermal radiation with wavelengths between about 7.0 micrometers (μm) and 18.0 μm. Accordingly, the transparent radiative cooling film preserves the color of a surface while passively cooling the surface. As used herein, the terms “preserves the color” and “preserving the color” refers to a color of a surface being visible (i.e., preserved) to an observer after the surface has been coated with a transparent radiative cooling film as described herein.

The transparent radiative cooling films described herein may be used to coat surfaces of articles and structures such as buildings, vehicles and the like. Non-limiting examples of coated surfaces include exterior surfaces of office buildings, industrial buildings, residential buildings, sports stadiums, and vehicle body panels. Utilization of the transparent radiative cooling films described herein provides passive cooling of surfaces while preserving the color of such surfaces. As used herein, the term “passively cooled” and “passive cooling” refers to the dissipation of heat by thermal radiation emission. Accordingly, colored surfaces coated with a transparent radiative cooling film as described herein are passively cooled and display the color of the surface to an observer. Various embodiments of transparent radiative cooling films and methods for using the same will be described in further detail herein with specific reference to the appended drawings.

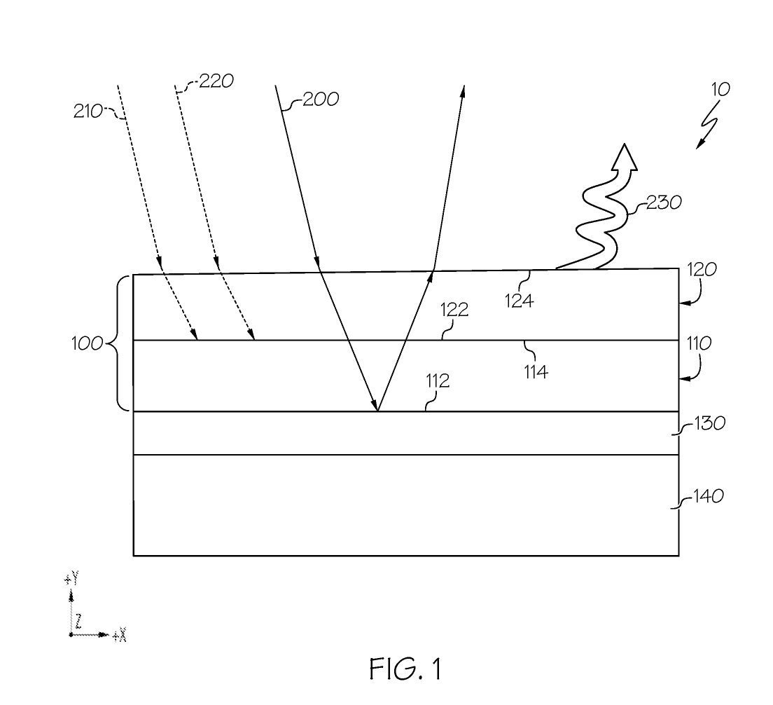

FIG. 1 generally depicts one embodiment of a transparent radiative cooling film. The transparent radiative cooling film includes a UV/IR cut layer and a radiative cooling layer. As used herein, the term “UV/IR cut layer” refers to a layer, or a plurality of layers, wherein reflection or absorption of electromagnetic radiation in the UV spectrum with wavelengths between about 0.3 μm and about 0.2 μm, and reflection and absorption of electromagnetic radiation in the IR spectrum with wavelengths between about 1.0 μm and about 5.0 μm, are equal to or greater than 60% when the UV/IR cut layer is exposed to sunlight. The term “radiative cooling layer” used herein refers to a layer, or a plurality of layers, wherein emission of electromagnetic radiation in the IR spectrum with wavelengths between about 7.0 μm and 18.0 μm is greater than 60% when the radiative cooling layer is exposed to sunlight. The UV/IR cut layer may extend across a color layer, e.g., a paint layer, and the radiative cooling layer may extend across the UV/IR cut layer. In combination, the UV/IR cut layer and the radiative cooling layer provide a transparent radiative cooling film that is transparent to visible electromagnetic radiation, absorbs and/or reflects UV and IR electromagnetic radiation, and emits thermal radiation such that passive cooling of the color layer is provided.

It should be understood that when electromagnetic radiation is incident on a surface, the total radiation energy is absorbed (absorptivity), reflected (reflectivity) or transmitted (transmissivity) by the surface. That is, the sum (in percent) of electromagnetic radiation absorbed by the surface, reflected by the surface, and transmitted through the surface is 100%. The absorption of electromagnetic radiation by a surface can be determined by measuring the transmission and reflection of the electromagnetic radiation through and by the surface, respectively (i.e., % absorption=100%−% transmission−% reflection). Also, the emissivity of electromagnetic radiation from the surface can be estimated as being equal to the absorption of electromagnetic radiation by the surface per Kirchhoff's law of thermal radiation. Particularly, Kirchhoff's law of thermal radiation states that for an arbitrary body emitting and absorbing thermal radiation in thermodynamic equilibrium, the emissivity is equal to the absorptivity.

While not being bound by theory, it is hypothesized that the net cooling power density P_{cool} provided by a radiative cooling film on a surface may be described by the relation:

P_{cool}(T)=P_{rad}(T)−Pₐₜₘ(T_{amb})−P_{Sun}−P_{cond+conv} (1)

where P_{rad}(T) is the thermal radiation power density radiated from the radiative cooling film, Pₐₜₘ(T_{amb}) is the absorbed power density due to surrounding atmospheric thermal radiation, Pₛᵤₙ is the absorbed power density of the radiative cooling film facing the sun, and P_{cond+conv} is the power density lost due to convection and conduction. To achieve radiative cooling, a radiative cooling film should: (1) emit thermal radiation (P_{rad}) at wavelengths corresponding to a “transparency window” in the atmosphere between about 8.0 μm and about 13.0 μm; (2) minimize the absorbed power density due to surrounding atmospheric thermal radiation (Pₐₜₘ) by minimizing emission at wavelengths where the atmosphere is opaque; (3) reflect sunlight to minimize P_{Sun}; and (4) minimize conductive and convective heating due to contact with surrounding air. Accordingly, the more efficient a radiative cooling film reflects undesired electromagnetic radiation and emits thermal radiation with wavelengths between about 8.0 μm and about 13.0 μm, the greater the passive cooling provided by the radiative cooling film.

Still referring to FIG. 1, one embodiment of an article 10 coated with a transparent radiative cooling film 100 comprising a UV/IR cut layer 110 and a radiative cooling layer 120 extending across the UV/IR cut layer 110 is depicted. The UV/IR cut layer 110 includes an inner surface 112 and an outer surface 114. As used herein, the term “inner surface” refers to a surface or boundary that faces a surface of an article on which the transparent radiative cooling film 100 is disposed and the term “outer surface” refers to a surface or boundary that faces sunlight when the transparent radiative cooling film 100 is exposed to sunlight. The radiative cooling layer 120 includes an inner surface 122 and an outer surface 124. An interface (not labeled) may be present between the outer surface 114 of the UV/IR cut layer 110 and the inner surface 122 of the radiative cooling layer 120. In embodiments, the UV/IR cut layer 110 extends across a color layer 130 that may be disposed on a panel or article 140. In such embodiments, the inner surface 112 of the UV/IR cut layer may be in contact with the color layer 130. As used herein, the term “color layer” refers to a layer that has a desired color when exposed to sunlight and viewed by an observer. Non-limiting examples of a color layer include a paint layer with a desired color, a polymer layer with a desired color, an anodized aluminum layer with a desired color, a multilayer interference thin film with a desired color, and the like. It should be understood that a color layer may be disposed on a panel or article formed from any type of material, illustratively including but not limited to, metals, alloys, polymers, ceramics, carbon, wood, and combinations thereof. It should also be understood that a color layer may be a panel or article itself, e.g., an article that has a desired color without an additional layer providing a desired color. Non-limiting examples of such a color layer include a polymer article with a desired colored surface (e.g., a chair or a table made from a polymer material), a metal article with a desired colored surface (e.g., polished brass), a ceramic article with a desired color surface, a glass article with a desired color, and the like.

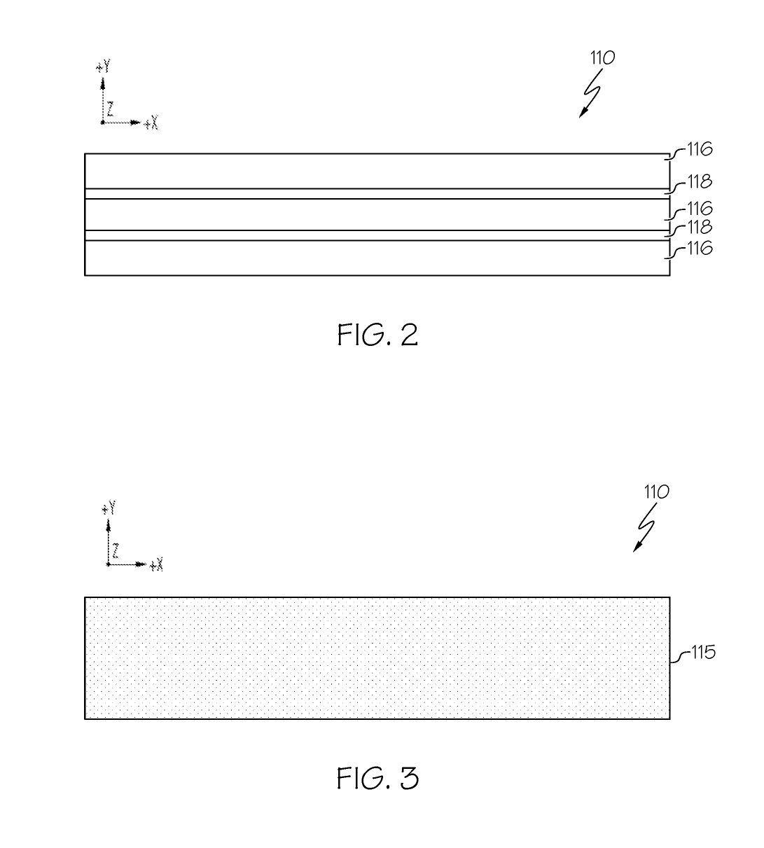

Referring now to FIG. 2, in embodiments, the UV/IR cut layer 110 may include an oxide layer 116 and a metal layer 118. In some embodiments, the UV/IR cut layer 110 may include a plurality of oxide layers 116 and a plurality of metal layers 118, for example alternating oxide layers 116 and alternating metal layers 118 (also referred to herein as “alternating layers of oxide and metal”). The alternating oxide layers 116 may be formed from at least one of titanium oxide (TiO₂), silicon oxide (SiO₂), cerium oxide (CeO₂), aluminum oxide (Al₂O₃), yttrium oxide (Y₂O₃), niobium oxide (Nb₂O₅), and combinations thereof. The oxide layers 116 may have a thickness between about 10 nanometers (nm) and about 100 nm. For example, the alternating oxide layers 116 may have a thickness greater than or equal to 10 nm, 20 nm, 30 nm, 40 nm, 50 nm, 60 nm, 70 nm, 80 nm, or 90 nm, and less than or equal to 100 nm, 90 nm, 80 nm, 70 nm, 60 nm, 50 nm, 40 nm, 30 nm or 20 nm. In some embodiments, the oxide layers 116 may have a thickness greater than or equal to 20 nm and less than or equal to 80 nm. In such embodiments, the alternating oxide layers 116 may have a thickness greater than or equal to 30 nm and less than or equal to 70 nm, for example greater than or equal to 40 nm and less than or equal to 60 nm.

The alternating metal layers 118 may be formed from metals and/or alloys illustratively including but not limited to silver (Ag), gold (Au), copper (Cu), alloys thereof, silver-aluminum (Ag—Al) alloys, and copper-zinc (Cu—Zn) alloys. The alternating metal layers 118 may have a thickness between about 2 nm and about 30 nm. For example, the alternating metal layers 118 may have a thickness greater than or equal to 2 nm, 4 nm, 6 nm, 8 nm, 10 nm, 12 nm, 16 nm, 20 nm, 24 nm or 28 nm, and less than or equal to 30 nm, 26 nm, 22 nm, 18 nm, 16, nm, 14 nm, 12 nm, 10 nm, 8 nm, 6 nm or 4 nm. In some embodiments, the alternating metal layers 118 may have a thickness greater than or equal to 4 nm and less than or equal to 20 nm. In such embodiments, the alternating metal layers 118 may have a thickness greater than or equal to 6 nm and less than or equal to 16 nm, for example greater than or equal to 10 nm and less than or equal to 14 nm.

Referring now to FIG. 3, in embodiments, the UV/IR cut layer 110 may be a color filter layer 115. As used herein, the term “color filter layer” refers to a layer that is transparent to the first range of electromagnetic radiation 200 (FIG. 1) in the visible spectrum and reflects and/or absorbs the second range of electromagnetic radiation 210 in the UV spectrum and the third range of electromagnetic radiation 220 in the IR spectrum. In some embodiments the color filter layer 115 is a dichroic color filter layer formed from a multilayer thin film. In other embodiments, the color filter layer 115 is a gel color filter layer formed from a gelatin gel. In embodiments where the color filter layer 115 is a dichroic color filter, the color filter layer 115 may have a thickness between about 50 nm and about 1000 nm. For example, the color filter layer 115 may have a thickness greater than or equal to 50 nm, 100 nm, 200 nm, 300 nm, 400 nm, 500 nm, 600 nm, 700 nm, 800 nm or 900 nm, and less than or equal to 1000 nm, 900 nm, 800 nm, 700 nm, 600 nm, 500 nm, 400 nm, 300 nm, 200 nm or 100 nm. In embodiments where the color filter layer 115 is a gel color filter, the color filter layer 115 may have a thickness between about 10 μm and about 200 μm. For example, the color filter layer 115 may have a thickness greater than or equal to 10 μm, 30 μm, 50 μm, 70 μm, 90 μm, 110 μm, 130 μm, 150 μm, 170 μm, or 190 μm, and less than or equal to 200 μm, 180 μm, 160 μm, 140 μm, 120 μm, 100 μm, 80 μm, 60 μm, 40 μm or 20 μm.

In embodiments, the first range of electromagnetic radiation 200 that is transmitted through the color filter layer 115 corresponds to the desired color of the color layer 130. For example, if the color layer 130 reflects a blue color with wavelengths between about 0.450 μm and about 0.495 μm, the first range of electromagnetic radiation 200 that is transmitted through the color filter layer 115 is between about 0.450 μm and about 0.495 μm. In the alternative, if the color layer 130 reflects a red color with wavelengths between about 0.620 μm and about 0.750 μm, the first range of electromagnetic radiation 200 that is transmitted through the color filter layer 115 is between about 0.620 μm and about 0.750 μm.

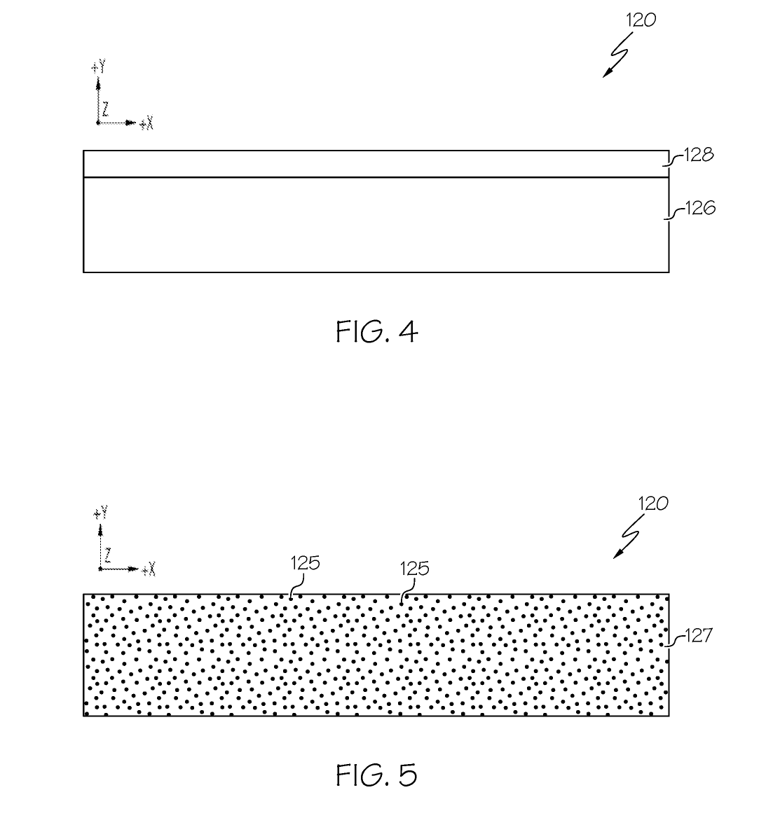

Referring now to FIG. 4, in embodiments, the radiative cooling layer 120 may include a first layer 126 and a second layer 128. The first layer 126 may be formed from an oxide and the second layer 128 may be formed from a polymer. The oxide from which the first layer 126 is formed may be SiO₂ and the polymer from which the second layer 128 is formed may be a polymeric organosilicon compound such as polydimethylsiloxane (PDMS), polymethylpentene (PMP), and combinations thereof. The first layer 126 of the radiative cooling layer 120 may have a thickness between about 100 μm and about 1500 μm. For example, the first layer 126 may have a thickness greater than or equal to 100 μm, 150 μm, 200 μm, 250 μm, 300 μm, 350 μm, 375 μm, 400 μm, 420 μm, 440 μm, 460 μm, 470 μm, 480 μm, 490 μm, 500 μm, 510 μm, 520 μm, 530 μm, 540 μm, 560 μm, 580 μm, 600 μm, 650 μm, 700 μm, 750 μm, 800 μm, 900 μm, 1000 μm, 1200 μm or 1400 μm, and less than or equal to 1500 μm, 1300 μm, 1100 μm, 900 μm, 750 μm, 700 μm, 650 μm, 600 μm, 580 μm, 560 μm, 540 μm, 530 μm, 520 μm, 510 μm, 500 μm, 490 μm, 480 μm, 470 μm, 460 μm, 440 μm, 420 μm, 400 μm, 375 μm, 350 μm, 300 μm, 250 μm, 200 μm or 150 μm. In embodiments, the first layer 126 may have a thickness greater than or equal to 400 μm and less than or equal to 600 μm. In such embodiments, the first layer 126 may have a thickness greater than or equal to 460 μm and less than or equal to 540 μm, for example greater than or equal to 480 μm and less than or equal to 520 μm.

The second layer 128 of the radiative cooling layer 120 may have a thickness between about 10 μm and about 500 μm. For example, the second layer 128 may have a thickness greater than or equal to 10 μm, 30 μm, 50 μm, 70 μm, 80 μm, 90 μm, 100 μm, 110 μm, 120 μm, 140 μm, 160 μm, 180 μm, 200 μm, 250 μm, 300 μm, 350 μm, 400 μm or 450 μm, and less than or equal to 500 μm, 450 μm, 400 μm, 350 μm, 300 μm, 250 μm, 200 μm, 180 μm, 160 μm, 140 μm, 120 μm, 110 μm, 100 μm, 90 μm, 80 μm, 70 μm, 50 μm, or 30 μm. In embodiments, the second layer 128 has a thickness greater than or equal to 50 μm and less than or equal to 150 μm. In such embodiments, the second layer 128 may have a thickness greater than or equal to 80 μm and less than or equal to 120 μm, for example greater than or equal to 90 μm and less than or equal to 110 μm.

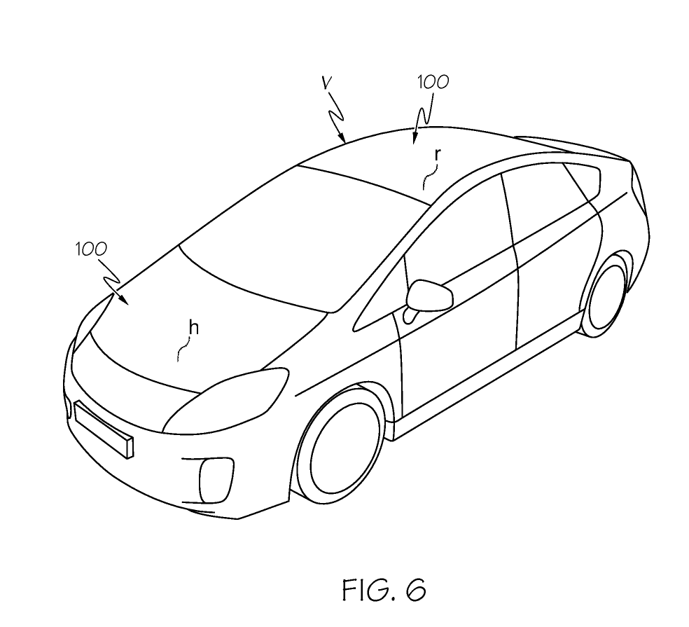

Referring now to the FIG. 5, in embodiments, the radiative cooling layer 120 may include oxide particles 125 disposed in a polymer layer 127. The oxide particles 125 may be formed from an oxide, e.g., SiO₂, and have an average particle diameter between about 1 μm and about 50 μm. For example, the oxide particles 125 may have an average particle diameter greater than or equal to 1 μm, 3 μm, 4 μm, 5 μm, 6 μm, 7 μm, 8 μm, 9 μm, 10 μm, 11 μm, 12 μm, 13 μm, 14 μm, 16 μm, 18 μm, 20 μm, 24 μm, 28 μm, 32 μm, 36 μm, 40 μm or 45 μm, and less than or equal to 50 μm, 45 μm, 40 μm, 36 μm, 32 μm, 28 μm, 24 μm, 20 μm, 18 μm, 16 μm, 14 μm, 12 μm, 10 μm, 9 μm, 8 μm, 7 μm, 5 μm, or 3 μm. In embodiments, the oxide particles 125 have an average particle diameter greater than or equal to 5 μm and less than or equal to 15 μm. In such embodiments, the oxide particles 125 may have an average particle diameter greater than or equal to 6 μm and less than or equal to 10 μm, for example greater than or equal to 7 μm and less than or equal to 9 μm.

The polymer layer 127 may be formed a polymeric organosilicon compound such as polydimethylsiloxane (PDMS), polymethylpentene (PMP), and combinations thereof, and may have a thickness between about 10 μm and 300 μm. That is, the polymer layer 127 with the oxide particles 125 disposed therein may have a thickness between about 10 μm and 300 μm. For example, the polymer layer 127 may have a thickness greater than or equal to 10 μm, 30 μm, 40 μm, 50 μm, 60 μm, 70 μm, 80 μm, 100 μm, 130 μm, 160 μm, 200 μm, 240 μm or 280 μm, and less than or equal to 300 μm, 260 μm, 220 μm, 180 μm, 150 μm, 130 μm, 110 μm, 90 μm, 80 μm, 70 μm, 60 μm, 50 μm, 40 μm, 30 μm or 20 μm. In embodiments, the polymer layer 127 may have a thickness greater than or equal to 20 μm and less than or equal to 80 μm. In such embodiments, the polymer layer 127 may have an thickness greater than or equal to 30 μm and less than or equal to 70 μm, for example greater than or equal to 40 μm and less than or equal to 60 μm.

The UV/IR cut layer 110 and the radiative cooling layer 120 are transparent to a first range of electromagnetic radiation 200 in the visible spectrum, but are not transparent to a second range of electromagnetic radiation 210 in the UV spectrum and a third range of electromagnetic radiation 220 in the IR spectrum. In embodiments where the UV/IR cut layer 110 comprises alternating oxide layers 116 and alternating metal layers 118 (FIG. 2), an average transmission of a first range of electromagnetic radiation 200 in the visible spectrum with wavelengths between about 0.380 μm and about 0.750 μm may be equal to or greater 60%, for example equal to or greater than 70%, equal to or greater than 80%, or equal to or greater than 90% when the UV/IR cut layer 110 is exposed to sunlight. As used herein the terms “average transmission”, “average reflection”, “average absorption” and “average emission” refer to an average value within a given range of electromagnetic radiation wavelengths calculated from at least 5 equidistant points on a plot of transmission, reflection, absorption and emission, respectively, as a function of electromagnetic radiation wavelength. In embodiments where the UV/IR cut layer 110 comprises a color filter layer 115 (FIG. 3), the first range of electromagnetic radiation 200 in the visible spectrum corresponds to the color of the color filter layer 115. That is, the first range of electromagnetic radiation may not span the entire visible spectrum but may only span wavelengths corresponding to a given color, for example wavelengths between about 0.380 μm and about 0.450 μm, wavelengths between about 0.450 μm and about 0.495 μm, wavelengths between about 0.495 μm and 0.570 about μm, wavelengths between about 0.590 μm and about 0.620 μm, or wavelengths between about 0.620 μm and about 0.750 μm. In such embodiments, an average transmission of the first range of electromagnetic radiation 200 in the visible spectrum through the color filter layer 115 may be equal to or greater 60%, for example equal to or greater than 70%, equal to or greater than 80%, or equal to or greater than 90% when the color filter layer 115 is exposed to sunlight.

The UV/IR cut layer 110 is not transparent to a second range of electromagnetic radiation in the UV spectrum or a third range of electromagnetic radiation in the IR spectrum. Particularly, an average reflection or an average absorption of a second range of electromagnetic radiation with wavelengths between about 0.300 μm and about 0.200 μm by the UV/IR cut layer 110 formed from the alternating oxide layers 116 and alternating metal layers 118 and/or the color filter layer 115 may be equal to or greater than then 60%, for example equal to or greater than 70%, equal to or greater than 80%, or equal to or greater than 90% when the UV/IR cut layer 110 is exposed to sunlight. Also, an average reflection of a third range of electromagnetic radiation with wavelengths between about 1.0 μm and about 5.0 μm by the UV/IR cut layer 110 formed from the alternating oxide layers 116 and alternating metal layers 118 and/or the color filter layer 115 may be equal to or greater than then 60%, for example equal to or greater than 70%, equal to or greater than 80%, or equal to or greater than 90% when the UV/IR cut layer 110 is exposed to sunlight.

The radiative cooling layer 120 emits thermal radiation to the atmosphere. Particularly, an average emission of a fourth range of electromagnetic radiation in the IR spectrum with wavelengths between about 7.0 μm and about 18.0 μm from the radiative cooling layer 120 formed from the oxide layer 126 and the polymer layer 128 and/or the oxide particles 125 disposed in the polymer layer 127 may be equal to or greater than then 60%, for example equal to or greater than 70%, equal to or greater than 80%, or equal to or greater than 90% when the radiative cooling layer 120 is exposed to sunlight.

In combination, an average transmission of the first range of electromagnetic radiation in the visible spectrum through the transparent radiative cooling film 100 comprising the UV/IR cut layer 110 and radiative cooling layer 120 may be equal to or greater than then 60%, for example equal to or greater than 70%, equal to or greater than 80%, or equal to or greater than 90% when the transparent radiative cooling film 100 is exposed to sunlight. An average reflection or an average absorption of the second range of electromagnetic radiation in the UV spectrum with wavelengths between about 0.300 μm and 0.200 μm by the transparent radiative cooling film 100 may be equal to or greater than then 60%, for example equal to or greater than 70%, equal to or greater than 80%, or equal to or greater than 90% when the transparent radiative cooling film 100 is exposed to sunlight. An average reflection of the third range of electromagnetic radiation in the IR spectrum with wavelengths between about 1.0 μm and about 5.0 μm by the transparent radiative cooling film 100 may be equal to or greater than then 60%, for example equal to or greater than 70%, equal to or greater than 80%, or equal to or greater than 90% when the transparent radiative cooling film 100 is exposed to sunlight. An average emission of the fourth range of electromagnetic radiation in the IR spectrum with wavelengths between about 7.0 μm and about 18.0 μm by the transparent radiative cooling film 100 may be equal to or greater than then 60%, for example equal to or greater than 70%, equal to or greater than 80%, or equal to or greater than 90%.

Referring now to FIG. 6, embodiments of a vehicle ‘V’ with a transparent radiative cooling film 100 is depicted. Particularly, FIG. 6 depicts the vehicle V with a hood panel ‘h’ and a roof panel ‘r’. The roof panel ‘r’ and the hood panel ‘h’ comprise a color layer (not shown) and a transparent radiative cooling film 100 extending across the color layer. The transparent radiative cooling film 100 includes a UV/IR cut layer 110 (FIG. 1) and a radiative cooling layer 120 (FIG. 1). In some embodiments, the transparent radiative cooling film 100 comprises a UV/IR cut layer 110 formed from alternating oxide layers 116 and alternating metal layers 118 as depicted in FIG. 3. In other embodiments, the transparent radiative cooling film 100 comprises a UV/IR cut layer 110 formed from a color filter layer 115 as depicted in FIG. 4. In still other embodiments, the UV/IR cut layer 110 is formed both a color filter layer 115 and alternating oxide layers 116 and alternating metal layers 118. The radiative cooling layer 120 may be formed from a single oxide layer 126, e.g., a single SiO₂ layer, or an oxide layer 126 and a polymer layer 128 as depicted in FIG. 4. In the alternative, or in addition to, the radiative cooling layer 120 may include oxide particles 125, e.g., SiO₂ particles, disposed in a polymer layer 127 as depicted in FIG. 5. When exposed to sunlight the transparent radiative cooling film 100 preserves the color of the hood panel h and roof panel r, blocks the color layer from UV and IR electromagnetic radiation, and emits thermal radiation to the atmosphere such that radiative cooling of the hood panel h and roof panel r is provided. It should be understood that other panels of the vehicle V may include the transparent radiative cooling film 100.

### Examples

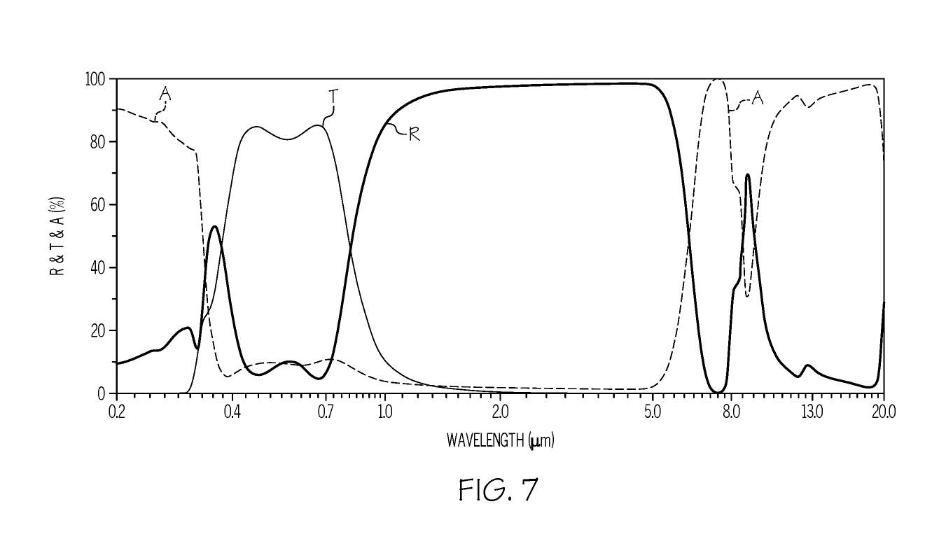

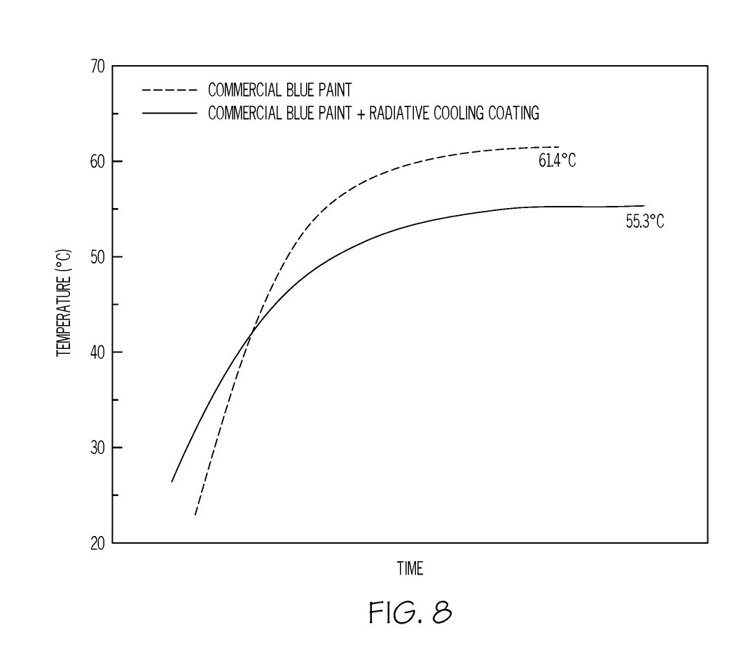

Referring now to FIGS. 1, 7 and 8, radiative cooling properties for a transparent radiative cooling film 100 are depicted. Particularly, reflection (labeled ‘R’), transmission (labeled ‘T’) and absorption (labeled ‘A’) of electromagnetic radiation by the transparent radiative cooling film 100 exposed to simulated sunlight is graphically depicted in FIG. 7. Measured equilibrium temperatures for surfaces coated with blue paint (i.e., a blue color layer), with and without the transparent radiative cooling film 100 on the blue color layer, and exposed to simulated sunlight are graphically depicted in FIG. 8. The transparent radiative cooling film 100 included a UV/IR cut layer 110 formed from alternating oxide layers 116 and alternating metal layers 118. The alternating oxide layers 116 and alternating metal layers 118 of the UV/IR cut layer 110 included three oxide layers 116 formed from TiO₂ and two metal layers 118 formed from Ag positioned between the three layers of TiO₂. A first oxide layer 116 of TiO₂ in contact with the blue paint layer had a thickness of about 35 nm, and a first metal layer 118 of Ag positioned above (+Y direction) and extending across the first oxide layer 116 of TiO₂ had a thickness of about 12 nm. A second oxide layer 116 of TiO₂ positioned above (+Y direction) and extending across the first metal layer 118 of Ag had a thickness of about 85 nm and a second metal layer 118 of Ag positioned above (+Y direction) and extending across the second oxide layer 116 of TiO₂ had a thickness of about 12 nm. A third oxide layer of TiO₂ positioned above and extending across the second metal layer of Ag had a thickness of about 35 nm. A radiative cooling layer 120 formed from a single layer of SiO₂ with a thickness of about 500 μm was positioned over (+Y direction) and extended across the UV/IR cut layer 110.

Referring to FIG. 7, the average transmission T of a first range of electromagnetic radiation in the visible spectrum with wavelengths between about 0.400 μm and about 0.700 μm through the transparent radiative cooling film 100 was more than 80% and the average absorption A of a second range of electromagnetic radiation in the UV spectrum with wavelengths between about 0.340 μm and about 0.200 μm by the transparent radiative cooling film 100 was more than 70%. Also, the average reflection of a third range of electromagnetic radiation in the IR spectrum with wavelengths between about 0.860 μm to about 6.0 μm by the transparent radiative cooling film 100 was more than 80% and the average emission of a fourth range of electromagnetic radiation in the IR spectrum with wavelengths between about 7.0 μm and 18.0 μm from the transparent radiative cooling film 100 was more than 70%. It should be understood that according to Kirchhoff's law of thermal radiation absorption by the transparent radiative cooling film 100 is equivalent to thermal radiation emission by the transparent radiative cooling film 100. That is, the curve A showing absorption of electromagnetic radiation with wavelengths between about 7.0 μm and 18.0 μm corresponds to emission of thermal radiation with wavelengths between about 7.0 μm and 18.0 μm. It should also be understood that alternative designs of the transparent radiative cooling film 100 can result in reflection, rather than absorption, of the second range of electromagnetic radiation in the UV spectrum, a more distinct or sharper “cut-off” between the first range of electromagnetic radiation in the visible spectrum and the second range of electromagnetic radiation in the UV spectrum, a more distinct or sharper “cut-off” between the first range of electromagnetic radiation in the visible spectrum the third range of electromagnetic radiation in the IR spectrum, and/or improved emission at wavelength between about 7.0 μm and about 18.0 μm. Such designs may include a UV/IR cut layer 110 with additional layers of oxide and/or additional layers of metal and/or a radiative cooling layer 120 with a polymer layer 128 extending across the SiO₂ layer 126.

Referring to FIG. 8, two surfaces with a blue color layer, i.e., two surfaces painted with blue paint, were exposed to simulated sunlight with an intensity of one (1) sun power (1000 W/m²). One of the blue painted surfaces was coated with the transparent radiative cooling film 100 described above with reference to FIG. 7 and one of the blue painted surfaces was uncoated. Temperatures of the two surfaces, one coated and one uncoated, were measured as a function of time during exposure to the simulated sunlight. As graphically depicted in FIG. 8, the uncoated surface labeled “commercial blue paint” reached an equilibrium temperature of about 61.4° C. and the coated surface labeled “commercial blue paint+radiative cooling film” reached an equilibrium temperature of about 55.3° C. Accordingly, the transparent radiative cooling film 100 provided an approximate 6° C. cooling (10% decrease) in temperature for the blue painted surface. Also, the color of the blue painted surface coated with the transparent radiative cooling film 100 was preserved.

The transparent radiative cooling films described herein may be used as part of an office building, industrial building, vehicle body panels, etc., to passively cool surfaces of such structures and articles. Although the embodiments disclosed and described in the figures depict transparent radiative cooling films for use with vehicle body panels, the transparent radiative cooling films may be used with other types of panels including but not limited to architectural panels formed from glass, sheet metal, concrete, and the like, to provide passive cooling.

The terms “generally,” “approximately,” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. In general, any quantitative comparison, value, measurement, or other representation is “about” or “approximate” whether or not expressly stated to be such. Also, start points and endpoints of ranges are disclosed herein and it is contemplated that any single start point can be used in conjunction with any given endpoint and the ranges include the start and endpoints unless otherwise noted. For example, the range “between about 0.380 μm and about 0.750 μm” includes the start point 0.380 μm and the end point 0.750 μm unless noted otherwise.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A transparent radiative cooling film comprising:
an ultraviolet/infrared (UV/IR) cut layer comprising at least one: (a) alternating layers oxide and alternating layers of metal; and (b) a color filter layer; and
a radiative cooling layer extending across the UV/IR cut layer, the radiative cooling layer comprising a metal oxide;
wherein:
an average transmission of a first range of electromagnetic radiation in the visible spectrum through the UV/IR cut layer is equal to or greater than 60% when the transparent radiative cooling film is exposed to sunlight;
an average reflection or average absorption of a second range of electromagnetic radiation in the UV spectrum by the UV/IR cut layer is equal to or greater than 60% when the transparent radiative cooling film is exposed to sunlight;
an average reflection of a third range of electromagnetic radiation in the IR spectrum with wavelengths between about 1.0 micrometers (μm) and about 5.0 μm by the UV/IR cut layer is equal to or greater than 60% when the transparent radiative cooling film is exposed to sunlight; and
an average emission of a fourth range of electromagnetic radiation in the IR spectrum with wavelengths between about 7.0 μm and about 18 μm from the radiative cooling layer is equal to or greater than 60%.

2. The transparent radiative cooling film of claim 1, wherein:
the UV/IR cut layer comprises the alternating layers of oxide and the alternating layers of metal;
the alternating layers of oxide are formed from at least one of TiO₂, SiO₂, CeO₂, Al₂O₃, Y₂O₃, Nb₂O₅, and combinations thereof; and
the alternating layers of metal are formed from at least one of Ag, Au, Cu, Ag—Al alloys, and Cu—Zn alloys.

3. The transparent radiative cooling film of claim 2, wherein the UV/IR cut layer comprises at least three metal oxide layers with a metal layer positioned between each of the at least three metal oxide layers.

4. The transparent radiative cooling film of claim 2, wherein the first range of electromagnetic radiation in the visible spectrum is between about 0.380 μm and about 0.750 μm.

5. The transparent radiative cooling film of claim 1, wherein the UV/IR cut layer is the color filter layer.

6. The transparent radiative cooling film of claim 5, wherein the first range of electromagnetic radiation in the visible spectrum is selected from the group consisting of wavelengths between about 0.380 μm and about 0.450 μm, wavelengths between about 0.450 μm and about 0.495 μm, wavelengths between about 0.495 μm and about 0.570 μm, wavelengths between about 0.590 μm and about 0.620 μm, and wavelengths between about 0.620 μm and about 0.750 μm.

7. The transparent radiative cooling film of claim 1, wherein the radiative cooling layer comprises a first SiO₂ layer and a second polymer layer extending across the first SiO₂ layer.

8. The transparent radiative cooling film of claim 1, wherein the radiative cooling layer comprises SiO₂ particles disposed within a polymer layer, the polymer layer comprising a polymeric organosilicon compound.

9. The transparent radiative cooling film of claim 1, further comprising a color layer reflecting a predetermined color when exposed to sunlight, wherein the transparent radiative cooling film extends across the color layer and the color layer is visible through the transparent radiative cooling film when viewed by an observer.

10. An article with a transparent radiative cooling film comprising:
a surface with a color layer reflecting a predetermined color when exposed to sunlight;
a transparent radiative cooling film extending across the color layer, the transparent radiative cooling film comprising:
a UV/IR cut layer; and
a radiative cooling layer extending across the UV/IR cut layer, the radiative cooling layer comprising SiO₂;
wherein:
an average transmission of a first range of electromagnetic radiation in the visible spectrum through the transparent radiative cooling film is equal to or greater than 60% when the transparent radiative cooling film is exposed to sunlight;
an average reflection or absorption of a second range of electromagnetic radiation in the UV spectrum by the transparent radiative cooling film is equal to or greater than 60% when the transparent radiative cooling film is exposed to sunlight;
an average reflection of a third range of electromagnetic radiation in the IR spectrum with wavelengths between about 1.0 μm and about 5.0 μm by the transparent radiative cooling film is equal to or greater than 60% when the transparent radiative cooling film is exposed to sunlight; and
an average emission of a fourth range of electromagnetic radiation in the IR spectrum with wavelengths between about 7.0 μm and about 18 μm from the transparent radiative cooling film is equal to or greater than 60%.

11. The article of claim 10, wherein:
the UV/IR cut layer comprises alternating layers of oxide and alternating layers of metal;
the alternating layers of oxide are formed from at least one of TiO₂, SiO₂, CeO₂, Al₂O₃, Y₂O₃, Nb₂O₅, and combinations thereof;
the alternating layers of metal are formed from at least one of Ag, Au, Cu, Ag—Al alloys, and Cu—Zn alloys; and
the first range of electromagnetic radiation in the visible spectrum is between about 0.380 μm and about 0.750 μm.

12. The article of claim 11, wherein the UV/IR cut layer comprises at least three metal oxide layers with a metal layer positioned between each of the at least three metal oxide layers.

13. The article of claim 10, wherein the UV/IR cut layer is a color filter layer.

14. The article of claim 13, wherein the first range of electromagnetic radiation in the visible spectrum is selected from the group consisting of wavelengths between about 0.380 μm and about 0.450 μm, wavelengths between about 0.450 μm and about 0.495 μm, wavelengths between about 0.495 μm and 0.570 about μm, wavelengths between about 0.590 μm and about 0.620 μm, and wavelengths between about 0.620 μm and about 0.750 μm.

15. The article of claim 10, wherein the radiative cooling layer comprises a first SiO₂ layer and a second polymer layer extending across the first SiO₂ layer.

16. The article of claim 10, wherein the radiative cooling layer comprises SiO₂ particles disposed within a polymer layer.

17. A vehicle comprising:
a body panel with a color layer reflecting a predetermined color when exposed to sunlight;
a transparent radiative cooling film extending across the color layer, the transparent radiative cooling film comprising:
a UV/IR cut layer; and
a radiative cooling layer extending across the UV/IR cut layer, the radiative cooling layer comprising SiO₂ and a polymer;
wherein:
an average transmission of a first range of electromagnetic radiation in the visible spectrum through the transparent radiative cooling film is equal to or greater than 60% when the transparent radiative cooling film is exposed to sunlight;
an average reflection or absorption of a second range of electromagnetic radiation in the UV spectrum by the transparent radiative cooling film is equal to or greater than 60% when the transparent radiative cooling film is exposed to sunlight;
an average reflection of a third range of electromagnetic radiation in the IR spectrum with wavelengths between about 1.0 micrometers (μm) and about 5.0 μm by the transparent radiative cooling film is equal to or greater than 60% when the transparent radiative cooling film is exposed to sunlight; and
an average emission of a fourth range of electromagnetic radiation in the IR spectrum with wavelengths between about 7.0 μm and about 18 μm from the transparent radiative cooling film is equal to or greater than 60%.

18. The vehicle of claim 17, wherein:
the UV/IR cut layer comprises alternating layers of oxide and alternating layers of metal;
the alternating layers of oxide are formed from at least one of TiO₂, SiO₂, CeO₂, Al₂O₃, Y₂O₃, Nb₂O₅, and combinations thereof;
the alternating layers of metal are formed from at least one of Ag, Au, Cu, Ag—Al alloys, and Cu—Zn alloys; and
the first range of electromagnetic radiation in the visible spectrum is between about 0.380 μm and about 0.750 μm.

19. The vehicle of claim 17, wherein:
the UV/IR cut layer is a color filter layer; and
the first range of electromagnetic radiation in the visible spectrum is selected from the group consisting of wavelengths between about 0.380 μm and about 0.450 μm, wavelengths between about 0.450 μm and about 0.495 μm, wavelengths between about 0.495 μm and 0.570 about μm, wavelengths between about 0.590 μm and about 0.620 μm, and wavelengths between about 0.620 μm and about 0.750 μm.

20. The vehicle of claim 17, wherein the radiative cooling layer comprises at least one of:
a first SiO₂ layer and a second polymer layer extending across the first SiO₂ layer; and
SiO₂ particles disposed in a polymer layer.
